(19) United States
(12) Patent Application Publication
(10) Pub. No.: US 2005/0137952 A1
(43) Pub. Date: Jun. 23, 2005

(54) Overseas remittance system and overseas remittance service server

(76) Inventors: Masatake Yamamoto, Tokyo (JP); Kimikazu Furuya, Tokyo (JP); Masahiko Matsuura, Tokyo (JP); Hideyuki Anno, Tokyo (JP)

Correspondence Address: YOUNG & THOMPSON, 745 SOUTH 23RD STREET, 2ND FLOOR, ARLINGTON, VA, 22202, US

(21) Appl. No.: 10/961,133

(22) Filed: Oct. 12, 2004

(30) Foreign Application Priority Data
Oct. 9, 2003 (JP) 2003-350643

(51) Int. Cl. G06F 17/60

(52) U.S. Cl. 705/35; 705/42

(57) ABSTRACT

When a terminal that can be connected to the Internet directs an overseas remittance unit to remit funds from an account of a financial institution to an account of an overseas financial institution, the overseas remittance unit first, based on this remittance instruction, requests a funds withdrawal unit to withdraw funds from the account of the financial institution. The funds withdrawal unit, in accordance with the request from the overseas remittance unit, withdraws funds from the account of the financial institution and then notifies the overseas remittance unit of the withdrawal. The overseas remittance then requests a funds transfer unit to remit the withdrawn funds to the account of the overseas financial institution. The funds transfer unit, in accordance with the request from the overseas remittance unit, remits the funds that have been withdrawn from the funds withdrawal unit to the account of the overseas financial institution.

### BACKGROUND OF THE INVENTION

1. Field of the Invention

The present invention relates to an overseas remittance system and overseas remittance method, and more particularly to an overseas remittance system and overseas remittance service server for carrying out procedures for overseas remittance via the Internet.

2. Description of the Related Art

Overseas residents conventionally perform overseas remittance for sending money that they have earned to families or relatives that are living in the home country. This type of overseas remittance constitutes an important source of income for financial institutions for developed nations and developing nations.

The rapid globalization of the economy in the last few decades has been accompanied by large-scale movements of populations across borders. Most developed nations that require manpower admit several million immigrants. The number of residents from foreign countries is therefore currently increasing rapidly, and the convenience of facilities for these foreign residents must be improved.

Conventional financial institutions have investigated entry into the overseas remittance market, but the presence or lack of a global network has formed a formidable barrier to entry. Even more important, a limited number of global enterprises, a group of niche traders, and a small number of underground remittance networks have dominated the overseas remittance market. However, informal remittance networks that lack any auditing capabilities have been a cause for concern in recent years as a result of government pressure and policies for countering terrorism, and overseas remittance by way of formal channels such as financial institutions and independent remittance businesspeople has therefore become necessary.

An overseas remittance system for carrying out overseas remittance procedures by way of a network is disclosed in, for example, Japanese Patent Laid-Open Publication No. 2002-197278. The technology disclosed in this publication is an overseas remittance system for implementing remittance from a country that is the remitting side to a country that is the receiving side, and includes a remitting-side data processor that is established in the country from which funds are sent and a receiving-side data processor that is established in the country in which funds are received. In this overseas remittance system, the receiving-side data processor issues cards in advance in which two associated card numbers are assigned respectively to the remittee and remitter, and the remitting-side data processor uses an international settlement processing network to transmit remittance data, which includes the amount of the remittance that the remitter has deposited and the card number of the remitter, to the receiving-side data processor. When the remittee both demands receipt of the remittance and presents the remittee's card number, the receiving-side data processor checks the association of the remittee's card number that has been presented by the remittee and the remitter's card number that is included in the remittance data, and approves receipt within the range of the remitted amount to the remittee if the association of the two card numbers is confirmed.

A system in which a user uses a communication terminal that belongs to the user to perform a remittance process is disclosed in, for example, Japanese Patent Laid-Open Publication No. 2002-41791. The art disclosed in this document is a remittance control system for controlling a remittance request from a remittance source user to a remittance destination user, and is provided with: account information storage means for storing at least information relating to the account held by remittance source user; first reception means for receiving remittance request signal that indicates information relating the communication terminal of the remittance destination user and information relating to the content of the remittance that has been sent from the communication terminal of the remittance source user; transmission means for transmitting to the communication terminal of the remittance destination user a remittance report signal for both indicating the notification of information specifying the remittance source user and information relating to the remittance content and for prompting transmission of information relating to the account desired for remittance; second reception means for receiving a remittance desired signal that includes information relating to the remittance desired account that is sent from the communication terminal of the remittance destination user; and remittance control means for executing remittance processing from the account held by the remittance source user to the remittance desired account based on the account information of the remittance source user, information relating to the remittance content, and information relating to the remittance desired account.

A combination of these different techniques of the prior art allows overseas remittance that features improved convenience over the prior art.

However, in the overseas remittance system that is disclosed in the above-described Japanese Patent Laid-Open Publication No. 2002-197278, remittance cannot be realized if the request for remittance from the remittee and the card number of the remittee are not presented. Furthermore, in the remittance control system that is disclosed in the above-described Japanese Patent Laid-Open Publication No. 2002-41791, the remittance destination user must select whether the remittance destination account is an already existing account or a new account. The problem therefore arises that, when the two systems are combined to realize overseas remittance, the remittance cannot be realized unless instructions are presented from the remittance destination.

### SUMMARY OF THE INVENTION

It is an object of the present invention to provide an overseas remittance system and an overseas remittance service server that allow overseas remittance to a desired account without causing undue inconvenience to the remitter.

In the present invention, when a terminal that can be connected to a network directs an overseas remittance means to remit funds from an account of a financial institution to an account of an overseas financial institution; the overseas remittance means first, based on this remittance instruction, requests a funds withdrawal means to withdraw funds from an account of a financial institution. The funds withdrawal means withdraws the funds from the account of the financial institution in accordance with the request from the overseas remittance means, and then notifies the overseas remittance means that the withdrawal of funds has been completed. The overseas remittance means submits a request to a funds transfer means to remit the funds that have been withdrawn by the funds withdrawal means to the account of the overseas financial institution. The funds transfer means remits the funds that have been withdrawn by the funds withdrawal means to the account of the overseas financial institution in accordance with the request from the overseas remittance means.

The above and other objects, features, and advantages of the present invention will become apparent from the following description with reference to the accompanying drawings, which illustrate examples of the present invention.

### BRIEF DESCRIPTION OF THE DRAWINGS

FIG. 1 shows an embodiment of the overseas remittance system of the present invention.

FIG. 2 is a flow chart for explaining processing when applying to an overseas remittance service server for an overseas remittance by means of the user terminals that are shown in FIG. 1.

FIG. 3 is a flow chart for explaining processing when an overseas remittance is performed using the remittance application information and the customer information that has been registered in the overseas remittance service server that is shown in FIG. 1.

### DETAILED DESCRIPTION OF THE PREFERRED EMBODIMENTS

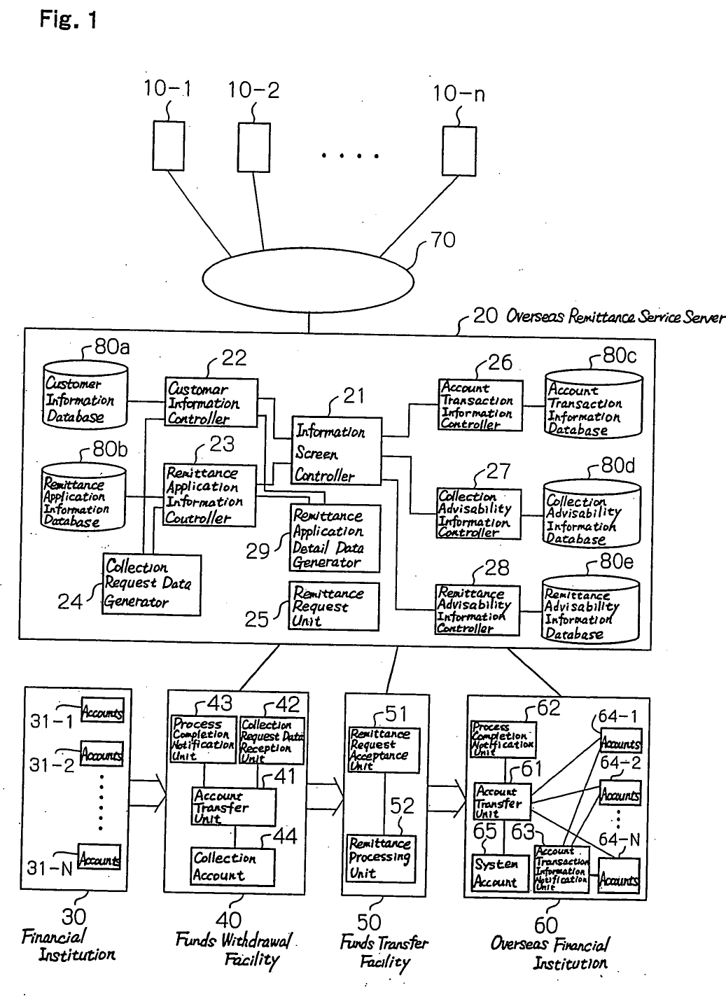

As shown in FIG. 1, the present embodiment is composed of: movable user terminals 10-1-10-n that are configured to allow connection to Internet 70 and that may be portable telephones or mobile terminals; overseas remittance service server 20 that is configured to allow connection to Internet 70; funds withdrawal facility 40; and funds transfer facility 50. Although only one each of financial institution 30 and overseas financial institution 60 are shown for the sake of simplifying the explanation, a plurality of financial institutions 30 and a plurality of overseas financial institutions 60 may also be present.

Overseas remittance service server 20 is an entity for performing remittance processing from accounts 31-1-31-N of financial institution 30 to accounts 64-1-64-N of overseas financial institution 60 in accordance with operations at user terminals 10-1-10-n; and is made up of: information screen controller 21, customer information controller 22, remittance application information controller 23, collection request data generator 24, remittance request unit 25, account transaction information controller 26, collection advisability information controller 27, remittance advisability information controller 28, and remittance application detail data generator 29.

Information screen controller 21 compiles information screens that are provided to user terminals 10-1-10-n by way of Internet 70 and offers these information screens in accordance with access from user terminals 10-1-10-n. Customer information controller 22 registers and manages the log-in passwords, the numbers of the accounts that are the remittance sources, and the numbers of the accounts that are the remittance destinations, which have been designated by users that have registered to use the overseas remittance system, in customer information database 80a, maintaining the association between these items of information. When an application for overseas remittance has been received in an information screen that has been provided from information screen controller 21, remittance application information controller 23 registers and manages the amount of this remittance and the log-in password of the user that has submitted the application as remittance application information in remittance application information database 80b, while maintaining the association between the amount and the password. Collection request data generator 24 generates collection request data based on the customer information that is managed by customer information controller 22 and the remittance application information that is managed by remittance application information controller 23 and issues a funds withdrawal request to funds withdrawal facility 40. Upon receiving notification from funds withdrawal facility 40 of the completion of the withdrawal of funds from accounts 31-1-31-N of financial institution 30, remittance request unit 25 submits an overseas remittance request to funds transfer facility 50 for remitting the funds that have been withdrawn by funds withdrawal facility 40 to overseas financial institution 60. Account transaction information controller 26 registers the transaction information of accounts 64-1-64-N of overseas financial institution 60 to account transaction information database 80c and manages the information. Collection advisability information controller 27, based on the collection results that are reported from funds withdrawal facility 40, determines the advisability of collecting the users funds, registers the result of this determination as collection advisability information in collection advisability information database 80d, and manages this information. Remittance advisability information controller 28 determines the advisability of remitting the user's funds based on the remittance result that has been notified from overseas financial institution 60, registers the result of this determination as remittance advisability information in remittance advisability information database 80e, and manages this information. Remittance application detail data generator 29 generates remittance application detail information based on the customer information that is managed by customer information controller 22 and remittance application information that is managed by remittance application information controller 23 and reports this information to overseas financial institution 60.

Funds withdrawal facility 40 is a facility for withdrawing remittance funds in accordance with a collection request from overseas remittance service server 20 by transferring funds from accounts 31-1-31-N of financial institution 30 to collection account 44; and is composed of: account transfer unit 41, collection request data reception unit 42, process completion notification unit 43, and collection account 44. Collection request data reception unit 42 accepts funds withdrawal requests from collection request data generator 24 of overseas remittance service server 20. When a funds withdrawal request has been received by collection request data reception unit 42, account transfer unit 41 transfers funds from accounts 31-1-31-N financial institution 30 to collection account 44. Process completion notification unit 43 notifies overseas remittance service server 20 that the transfer of funds from accounts 31-1-31-N of financial institution 30 to collection account 44 has been completed.

Funds transfer facility 50 is a facility for remitting funds from collection account 44 of funds withdrawal facility 40 to system account 65, which is a designated account of overseas financial institution 60, in accordance with a remittance request from overseas remittance service server 20; and is composed of remittance request acceptance unit 51 and remittance processing unit 52. Remittance request acceptance unit 51 accepts overseas remittance requests from remittance request unit 25 of overseas remittance service server 20. When an overseas remittance request is accepted by remittance request acceptance unit 51, remittance processing unit 52 remits funds from collection account 44 of funds withdrawal facility 40 to system account 65 of overseas financial institution 60.

Overseas financial institution 60, which is the remittance destination, is further provided with account transfer unit 61, process completion notification unit 62, and account transaction information notification unit 63. Based on remittance application detail data that have been notified from overseas remittance service server 20, account transfer unit 61 transfers funds that have been remitted from funds transfer facility 50 to system account 65 into accounts 64-1-64-N. Process completion notification unit 62 notifies overseas remittance service server 20 that the account transfer into accounts 64-1-64-N of the funds that have been remitted to system account 65 has been completed. Account transaction information notification unit 63 reports the transaction information of accounts 64-1-64-N to overseas remittance service server 20.

Explanation next regards the overseas remittance method in the overseas remittance system that is configured as described above.

A user who is to remit funds overseas using the overseas remittance system shown in FIG. 1 must first register as a user in overseas remittance service server 20. For this purpose, it is considered typical for the user to fill in items that include a password for logging in when using this overseas remittance system, the number of the account that is the remittance source, and the number of the account that is the remittance destination in a prescribed contract and provide this to the facility that operates overseas remittance service server 20. In the present embodiment, this user registration is realized using user terminals 10-1-10-n by way of Internet 70. In this case, users use user terminals 10-1-10-n to access the registration site of overseas remittance service server 20, whereupon an information screen for user registration is transmitted from information screen controller 21 of overseas remittance service server 20 and displayed on user terminals 10-1-10-n. The information screen that is displayed on user terminals 10-1-10-n is provided with areas for filling in items that include the log-in password for using this overseas remittance system, the account number of the remittance source, and the account number of the remittance destination. The users enter into these areas items that include the log-in passwords for using the overseas remittance system, the account numbers of the remittance sources, and the account numbers of the remittance destinations and transmit this information to overseas remittance service server 20, whereupon customer information controller 22 of overseas remittance service server 20 registers in customer information database 80a the items that include the log-in passwords, account numbers of the remittance sources, and the account numbers of the remittance destinations that have been transmitted in from user terminals 10-1-10-n, and manages this information. In addition, users must separately conclude an account contract with overseas financial institution 60 in advance.

Explanation next regards the processing when a user that has carried out user registration as described above uses the overseas remittance system to send funds overseas.

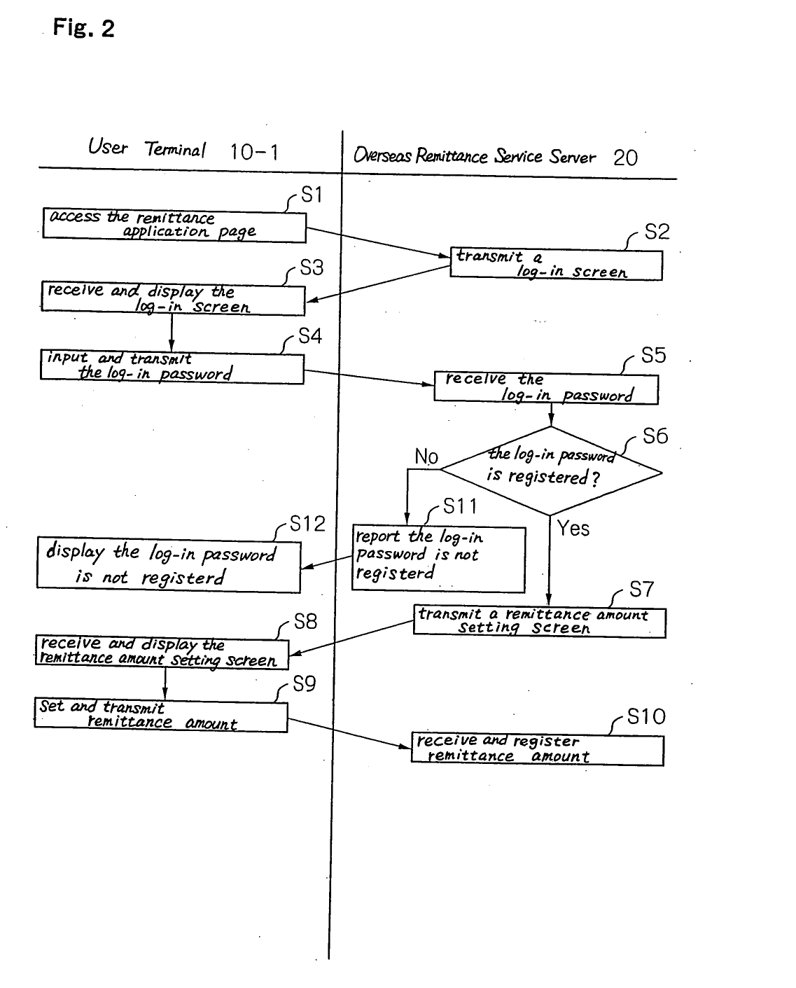

Explanation first regards the procedures when submitting an application for overseas remittance to overseas remittance service server 20 from user terminal 10-1 with reference to FIG. 2.

First, when the user uses user terminal 10-1 to access the remittance application page of overseas remittance service server 20 in Step S1, a log-in screen for logging into the remittance application page is transmitted from information screen controller 21 of overseas remittance service server 20 in Step S2. Then, in Step S3, this log-in screen is received and displayed by user terminal 10-1.

An area for entering the log-in password is provided in the log-in screen that has been transmitted from information screen controller 21 of overseas remittance service server 20 and received and displayed by user terminal 10-1. In Step S4, the user enters into this area the log-in password that was designated when performing user registration and transmits the password, whereupon this log-in password is received by overseas remittance service server 20 and transferred to customer information controller 22 in Step S5.

In customer information controller 22 of overseas remittance service server 20, a check is performed in Step S6 to determine whether the log-in password that has been transmitted in from user terminal 10-1 is registered in customer information database 80a. In this case, the log-in password that was designated when the user submitted the application is registered in customer information database 80a, and thus, when the log-in password that is transmitted in from user terminal 10-1 is registered in customer information database 80a, the user that is accessing the remittance application page is determined to be someone who has performed a user application. A remittance amount setting screen for setting the remittance amount is next transmitted from information screen controller 21 in Step S7. The remittance amount setting screen that is transmitted from information screen controller 21 is received and displayed by user terminal 10-1 in Step S8.

An area for selecting or entering the remittance amount is provided in the remittance amount setting screen that has been transmitted from information screen controller 21 and then received and displayed by user terminal 10-1. The remittance amount is then set in the area that is provided in this remittance amount setting screen and transmitted in Step S9, and the remittance amount that has been transmitted from user terminal 10-1 is next received by overseas remittance service server 20 in Step S10. In remittance application information controller 23 of overseas remittance service server 20, the remittance amount that has been received is registered in remittance application information database 80b as remittance application information that is placed in association with the log-in password that was entered in log-in screen in Step S4.

On the other hand, if the log-in password that is transmitted in from user terminal 10-1 is not registered in customer information database 80a, this determination is reported from overseas remittance service server 20 to user terminal 10-1 in Steps S11 and S12.

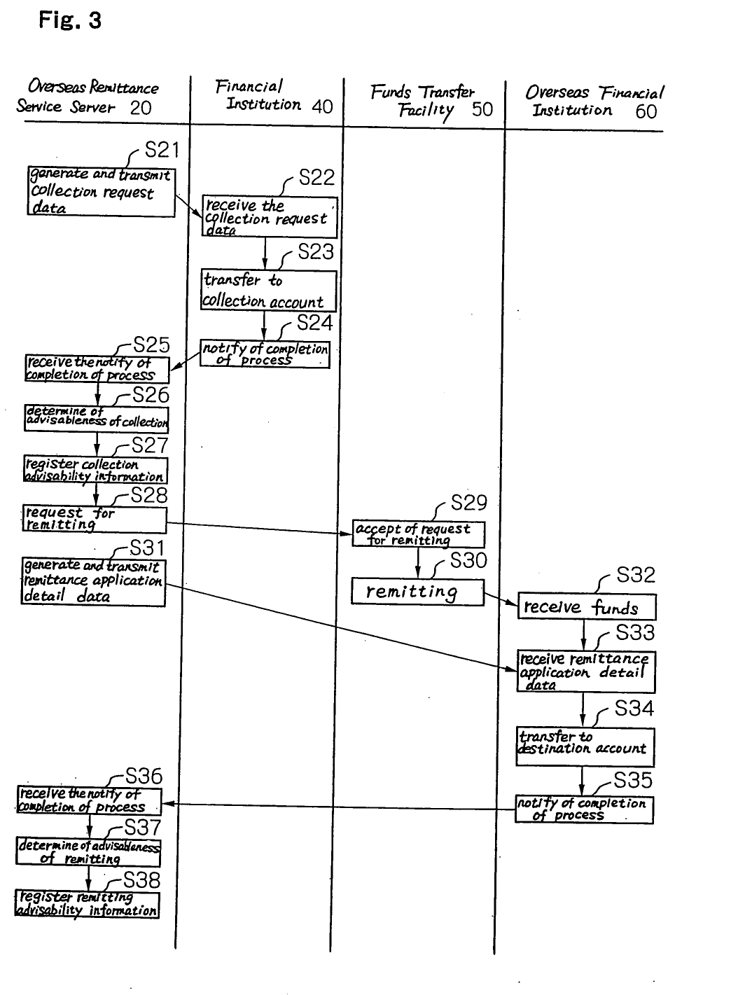

Explanation next uses FIG. 3 to describe the procedures when remitting funds overseas using the remittance application information and customer information that are registered in overseas remittance service server 20 by the above-described series of processes.

First, based on the customer information that is registered in customer information database 80a and managed by customer information controller 22 and the remittance application information that is registered in remittance application information database 80b and managed by remittance application information controller 23, collection request data generator 24 of overseas remittance service server 20 generates collection request data and transmits these data in Step S21. Here, the log-in password, the number of the account that is the remittance source, and the number of the account that is the remittance destination that have been designated by a user that has registered to use the overseas remittance system are registered in association with each other in customer information database 80a, and the amount of remittance that the user has set is registered in association with the log-in password in remittance application information database 80b. As a result, collection request data generator 24 generates collection request data indicating that the remittance amount that has been registered in remittance application information database 80b is to be withdrawn from the account number of the remittance source that has been associated by customer information database 80a with the log-in password that is in turn associated with this remittance amount by remittance application information database 80b.

Collection request data that have been transmitted from collection request data generator 24 are received by collection request data reception unit 42 of funds withdrawal facility 40 in Step S22. Based on collection request data that have been received by collection request data reception unit 42, account transfer unit 41 of funds withdrawal facility 40 then transfers to collection account 44 the remittance amount that is contained in the collection request data from, of the accounts of financial institution 30, the account that corresponds with the account number of the remittance source that is contained in the collection request data.

When the account transfer to collection account 44 has been completed, process completion notification unit 43 of funds withdrawal facility 40 notifies overseas remittance service server 20 in Step S24 that the account transfer to collection account 44 has been completed. At this time, the collection result is notified from funds withdrawal facility 40 to overseas remittance service server 20. This collection result indicates whether, based on the collection request data, the remittance amount that is contained in the collection request data has been successfully collected from the account that corresponds to the account number of the remittance source that is contained in the collection request data, and is composed of information indicating whether collection was successful and the account number of the remittance source.

The notification from process completion notification unit 43 of funds withdrawal facility 40 is received by overseas remittance service server 20 in Step S25, whereupon collection advisability information controller 27 of overseas remittance service server 20 determines in Step S26 whether the collection from the user is advisable based on the collection result that was notified from funds withdrawal facility 40, and registers this determination result in collection advisability information database 80d as collection advisability information in Step S27. At this time, collection advisability information controller 27 refers to customer information database 80a, and registers the log-in password that is associated by customer information database 80a with the account number of the remittance source that is contained in the collection result in collection advisability information database 80d in association with the collection advisability information.

In overseas remittance service server 20, remittance request unit 25 transmits to funds transfer facility 50 in Step S28 an overseas remittance request for remitting to overseas financial institution 60 the funds that have been transferred to collection account 44 of funds withdrawal facility 40.

The overseas remittance request that has been transmitted from remittance request unit 25 of overseas remittance service server 20 is received by remittance request acceptance unit 51 of funds transfer facility 50 in Step S29, whereupon remittance processing unit 52 of funds transfer facility 50 remits the funds that have been transferred to collection account 44 of funds withdrawal facility 40 to system account 65 of overseas financial institution 60 in Step S30. Further, at this time, remittance application detail data generator 29 of overseas remittance service server 20 generates in Step S31 remittance application detail data that include the account number of the remittance destination based on customer information that has been registered in customer information database 80a and remittance application information that has been registered in remittance application information database 80b, and notifies overseas financial institution 60. In this case, a log-in password, the account number of the remittance source, and the account number of the remittance destination that have been designated by a user that has registered to use the overseas remittance system are registered in association with each other in customer information database 80a, and further, the log-in password and remittance amount that has been set by the user are registered in association with each other in remittance application information database 80b. As a result, remittance application detail data generator 29 generates remittance application detail data that indicate that the remittance amount that has been registered in remittance application information database 80b is to be remitted to the account number of the remittance destination that is associated by customer information database 80a with the log-in password that is in turn associated with this remittance amount by remittance application information database 80b.

In overseas financial institution 60, funds that have been remitted from funds transfer facility 50 to system account 65 are received in Step S32. When the remittance application detail data that have been transmitted from remittance application detail data generator 29 of overseas remittance service server 20 are received in Step S33, account transfer unit 61 of overseas financial institution 60 in Step S34 transfers the funds that have been remitted to system account 65 to the account of accounts 64-1-64-N of overseas financial institution 60 that is contained in the remittance application detail data based on the remittance application detail data that have been reported from overseas remittance service server 20.

When the account transfer to the remittance destination account has been carried out by overseas financial institution 60, process completion notification that indicates that the account transfer to the remittance destination account has been carried out is transmitted to overseas remittance service server 20 from process completion notification unit 62 of overseas financial institution 60 in Step S35. At this time, the remittance result is also reported to overseas remittance service server 20 from overseas financial institution 60. This remittance result, based on the remittance application detail data, indicates that funds have been successfully remitted to the account that corresponds to the account number of the remittance destination that is included in the remittance application detail data and is composed of information that indicates whether remittance was accomplished and the account number of the remittance destination.

The notification from process completion notification unit 62 of overseas financial institution 60 is received by overseas remittance service server 20 in Step S36, whereupon remittance advisability information controller 28 determines in Step S37 whether remittance by the user is advisable based on the remittance result that was reported from overseas financial institution 60 and registers this determination result in remittance application information database 80e as remittance advisability information in Step S38. At this time, remittance advisability information controller 28 refers to customer information database 80a and registers the log-in password, which is associated by customer information database 80a with the account number of the remittance destination that is contained in the remittance result, in remittance advisability information database 80e in association with the remittance advisability information.

Explanation next regards the procedures when user terminals 10-1-10-n refer to account transaction information in accounts 64-1-64-N of overseas financial institution 60.

Account transaction information notification unit 63 of overseas financial institution 60 manages the account transaction information of accounts 64-1-64-N and periodically transmits this account transaction information to overseas remittance service server 20.

In overseas remittance service server 20, account transaction information controller 26 registers the account transaction information that has been reported from account transaction information notification unit 63 of overseas financial institution 60 in account transaction information database 80c. At this time, account transaction information controller 26 refers to customer information database 80a and registers the log-in password, which is associated by customer information database 80a with the account number of the remittance destination that is contained in the account transaction information, into account transaction information database 80c in association with the account transaction information. Account transaction information controller 26 subsequently uses the account transaction information that is periodically reported from account transaction information notification unit 63 of overseas financial institution 60 to update account transaction information database 80c.

Thus, when the account transaction information that is registered in account transaction information database 80c is referred to by user terminals 10-1-10-n, user terminals 10-1-10-n first access the account transaction information reference page of overseas remittance service server 20 and enter the log-in password. Account transaction information controller 26 then searches for the account transaction information of the account transaction information that is registered in account transaction information database 80c that has been placed in correspondence with the log-in password, and information screen controller 21 compiles an information screen that presents this account transaction information and transmits this screen to user terminals 10-1-10-n. In this way, information such as the deposit history, the withdrawal history, and the balance in accounts 64-1-64-N of overseas financial institution 60 can be displayed on user terminals 10-1-10-n, and this information can be consulted.

Explanation next regards procedures when user terminals 10-1-10-n refer to collection advisability information that is registered in collection advisability information database 80d and remittance advisability information that is registered in remittance advisability information database 80e.

When user terminals 10-1-10-n refer to collection advisability information that is registered in collection advisability information database 80d, user terminals 10-1-10-n first access a collection advisability information reference page of overseas remittance service server 20 and enter the log-in password. Collection advisability information controller 27 then searches for the collection advisability information of the collection advisability information that is registered in collection advisability information database 80d that has been associated with the log-in password, and information screen controller 21 compiles an information screen that presents this collection advisability information and transmits this screen to user terminals 10-1-10-n. In this way, the collection advisability information of users can be displayed on user terminals 10-1-10-n, and users can refer to the collection advisability information.

When user terminals 10-1-10-n refer to remittance advisability information that has been registered in remittance advisability information database 80e, user terminals 10-1-10-n first access the remittance advisability information reference page of overseas remittance service server 20 and enter the log-in password. Remittance advisability information controller 28 then searches for the remittance advisability information of the remittance advisability information that has been registered in remittance advisability information database 80e that has been associated with the log-in password, and information screen controller 21 compiles an information screen that presents this remittance advisability information and transmits the screen to user terminals 10-1-10-n. In this way, the remittance advisability information of users can be displayed on user terminals 10-1-10-n and users are able to refer to the remittance advisability information.

Explanation next regards the procedures for cancellation of a remittance application.

When users wish to cancel a remittance application after having submitted a remittance application by the procedures that are shown in FIG. 2, they first use user terminals 10-1-10-n to access the remittance cancellation page of overseas remittance service server 20 and enter the log-in password. If the account transfer to the collection account of Step S23 has still not been carried out, the remittance can be cancelled.

Explanation next regards the procedures when referring to the remittance acceptance state in overseas remittance service server 20.

When the remittance acceptance state in overseas remittance service server 20 is to be consulted by user terminals 10-1-10-n, user terminals 10-1-10-n first access the remittance acceptance state reference page of overseas remittance service server 20 and enter the log-in password. Information screen controller 21 then compiles an information screen that presents the users' remittance acceptance states and transmits this screen to user terminals 10-1-10-n. In this way, the remittance acceptance state in overseas remittance service server 20 can be displayed on user terminals 10-1-10-n, and users can check their own remittance acceptance states in overseas remittance service server 20 at any time.

The present invention, having the configuration described in the foregoing explanation, provides the following effects:

Users are able to implement “cashless” overseas remittance of funds without having to convert to cash.

The arrangement of a financial institution in the flow of funds and the interposition of a remittance system allows more effective auditing of overseas remittances.

The realization of financial teller business operations by electronic means allows a reduction of office work.

The use of movable devices such as portable telephones and mobile terminals as the terminals allows an improvement of convenience.

While a preferred embodiment of the present invention has been described using specific terms, such description is for illustrative purposes only, and it is to be understood that changes and variations may be made without departing from the spirit or scope of the following claims.

1. An overseas remittance system for sending funds from an account of a financial institution to an account of an overseas financial institution, comprising:
terminals that can connect to the internet;
overseas remittance means that is configured to allow connection to the Internet for performing a process of remitting funds from an account of said financial institution to an account of said overseas financial institution in accordance with operations at said terminals;
a funds withdrawal means for withdrawing remittance funds from an account of said financial institution in accordance with a collection request from said overseas financial institution; and
a funds transfer means for remitting funds that have been withdrawn by said funds withdrawal means to a designated account of said overseas financial institution in accordance with a remittance request from said overseas financial institution;
wherein said overseas remittance means comprises:
customer information control means for managing an account number of a remittance source and an account number of a remittance destination in association with identification information;
remittance application information control means for, when said identification information and a remittance amount have been designated by said terminal, managing these data in association with each other;
collection request data generation means for generating collection request data that include the account number of a remittance source and a remittance amount based on information that is managed by said customer information control means and information that is managed by said remittance application information control means and using the collection request data to submit a collection request to said funds withdrawal means;
remittance request means for submitting a remittance request to said funds transfer means when funds have been withdrawn by said funds withdrawal means; and
a remittance application detail data generation means for generating remittance application detail data that includes the account number of the remittance destination based on information that is managed by said customer information control means and information that is managed by said remittance application information control means and reporting this remittance application detail data to said overseas financial institution; and
wherein said overseas financial institution comprises:
account transfer means for carrying out an account transfer of funds that have been remitted to said designated account to a remittance destination account based on remittance application detail data that have been reported from said remittance application detail data generation means.

2. An overseas remittance system according to claim 1, wherein said overseas remittance means:
includes an account transaction information control means for managing account transaction information of the overseas financial institution that has been reported from said overseas financial institution; and
transmits said account transaction information to said terminals in accordance with requests from said terminals.

3. An overseas remittance system according to claim 1, wherein said overseas remittance means:
includes collection advisability information control means for determining the advisability of collecting funds based on collection results that are reported from said funds withdrawal means and that indicate whether funds have been successfully withdrawn from said financial institution, and managing this determination as collection advisability information; and
transmits said collection advisability information to terminals in accordance with requests from said terminals.

4. An overseas remittance system according to claim 1, wherein said terminals are configured to be movable.

5. An overseas remittance service server that is used in an overseas remittance system that includes at least: terminals that can be connected to the Internet; funds withdrawal means for withdrawing remittance funds from accounts of a financial institution; and funds transfer means for remitting funds that have been withdrawn by said funds withdrawal means to a designated account of an overseas financial institution; said overseas remittance service server comprising:
customer information control means for managing account numbers of remittance sources and account numbers of remittance destinations in association with identification information;
remittance application information control means for, when said identification information and a remittance amount have been designated at said terminals, managing these items of information in association with each other;
collection request data generation means for, based on information that is managed by said customer information control means and information that is managed by said remittance application information control means, generating collection request data that include the account number of a remittance source and a remittance amount, and using the collection request data to submit a collection request to said funds withdrawal means;
remittance request means for submitting a remittance request to said funds transfer means when funds have been withdrawn by said funds withdrawal means; and
remittance application detail data generation means for, based on information that is managed by said customer information control means and information that is managed by said remittance application information control means, generating remittance application detail data that include the account number of a remittance destination, and reporting this remittance application detail data to said overseas financial institution.

6. An overseas remittance service server according to claim 5, wherein said overseas remittance service server:
includes an account transaction information control means for managing account transaction information of said overseas financial institution that has been reported from said overseas financial institution; and
transmits said account transaction information to said terminals in response to requests from said terminals.

7. An overseas remittance service server according to claim 5, wherein said overseas remittance service server;
includes a collection advisability information control means for determining the advisability of collection based on a collection result that is reported from said fund withdrawal means and that indicates whether funds have been successfully withdrawn from said financial institution and managing this determination as collection advisability information; and
transmits said collection advisability information to said terminals in response to requests from said terminals.
